(19) United States
(12) Patent Application Publication
(10) Pub. No.: US 2005/0275717 A1
(43) Pub. Date: Dec. 15, 2005

(54) Method and apparatus for testing stereo vision methods using stereo imagery data

(75) Inventor: Theodore Armand Camus, Marlton, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(73) Assignee: SARNOFF Corporation

(21) Appl. No.: 11/149,687

(22) Filed: Jun. 10, 2005

Related U.S. Application Data
(60) Provisional application No. 60/578,708, filed on Jun. 10, 2004.

(51) Int. Cl. H04N 13/00

(52) U.S. Cl. 348/42

(57) ABSTRACT

A method and apparatus for generating stereo imagery scenario data to be used to test stereo vision methods such as detection, tracking, classification, steering, collision detection and avoidance methods is provided.

### CROSS-REFERENCE TO RELATED APPLICATIONS

This application claims the benefit of U.S. provisional patent application Ser. No. 60/578,708, filed Jun. 10, 2004, the entire disclosure of which is herein incorporated by reference.

### BACKGROUND OF THE INVENTION

1. Field of the Invention

Embodiments of the present invention generally relate to a method and apparatus for generating stereo imagery data, and, in particular, for generating stereo imagery scenarios for use in testing stereo vision based methods such as detection, tracking, classification, steering, collision detection, and/or avoidance methods.

2. Description of the Related Art

Evaluating stereo vision methods, such as detection, tracking, classification, steering, collision detection, and/or avoidance methods, can be troublesome, time consuming and costly for several reasons. For example, actual vehicle driving and crash testing in a specialized crash-test facility to generate such data is very expensive, perhaps several thousand dollars per collision. It is virtually impossible to test and record data for hundreds, if not thousands, of various scenarios using known methods. Low-speed collision scenarios reduce risk of injury and damage but still risk fender-benders if drivers are not careful. Additionally, it is difficult to carefully control vehicle speed and other parameters when attempting to simulate a collision scenario, especially in the safer low-speed case; thus, reducing the accuracy of the testing. Furthermore, illumination and other environmental conditions and effects are not commonly taken into account in a crash-test facility.

Alternatively, performing collision testing using toy models on a gantry system may provide realistic trajectory scenarios by computing modeling of vehicle trajectories, and computer control of the gantry axes positions. Additionally, this approach may use real stereo cameras. However, using this known approach to generate collision data can be slow and somewhat expensive. The target vehicles are, of course, only toy models. The backgrounds may be absent or unrealistic. It may be difficult to obtain realistic toy models of clutter, such as trees and road signs. Finally, environmental conditions such as rain, illumination and the like will not be taken into account. Furthermore, the gantry system has limitations relating to physical size of the set up, curvature of the road, arbitrary background, and the like.

Thus, there is a need for a method and apparatus for producing stereo imagery data for use in testing detection, tracking, classification, steering, collision detection, and/or avoidance methods in a process controlled, repeatable, cost efficient, safe and realistic manner.

### SUMMARY OF THE INVENTION

Embodiments of the present invention relate to a method and apparatus for generating stereo imagery scenario data and applying the generated scenario data to test stereo vision methods such as, by way of example, one or more of detection, tracking, classification, steering, collision detection and/or avoidance methods, or any combination thereof. Further embodiments include using stereo imagery data for creating a matrix of scenarios. In another embodiment, there is provided a method and apparatus for incorporating a limited set of real-world test scenarios to be recorded with live video and comparing those test scenarios with corresponding simulated video to validate the computer modeling process.

In accordance with one embodiment of the present invention, there is provided a method for testing a stereo vision method, comprising generating stereo imagery scenario data, and linking the generated stereo imagery scenario data to the stereo vision method under test.

In accordance with another embodiment of the present invention, there is provided an apparatus for testing a stereo vision method, comprising means for generating stereo imagery scenario data, and means for linking the generated stereo imagery scenario data to the stereo vision method under test.

### BRIEF DESCRIPTION OF THE DRAWINGS

So the manner in which the above recited features of embodiments of the present invention are obtained and can be understood in detail, a more particular description of embodiments of the present invention, briefly summarized above, may be had by reference to said embodiments thereof, illustrated in the appended drawings. It is to be noted; however, the appended drawings illustrate only typical embodiments of the present invention and are therefore not to be considered limiting of its scope, for the present invention may admit to other equally effective embodiments, wherein:

FIG. 1 illustrates a flow diagram of a method in accordance with an embodiment of the present invention;

FIG. 2 illustrates a flow diagram of a method in accordance with another embodiment of the present invention;

FIG. 3 illustrates a flow diagram of a method in accordance with yet another embodiment of the present invention; and

FIG. 4 depicts a block diagram of an image processing apparatus to implement the above methods in accordance with a further embodiment of the present invention.

### DETAILED DESCRIPTION

Embodiments of the present invention are directed to a method and apparatus for generating stereo image data to simulate, for example, one or more of vehicle steering, detection, tracking, classification, collision detection, and/or avoidance scenarios safely and in a controlled manner, with differing simulated vehicle models, vehicle textures, vehicle trajectories and other dynamics, background objects, environmental conditions such as illumination, or weather, and the like or any combination thereof. This stereo vision data is then used to test and verify the accuracy and completeness of stereo vision methods such as the on3 or more of detection, tracking, classification, steering, collision detection, and/or avoidance methods discussed herein, or any combination thereof. These six types of stereo vision methods are mentioned throughout this patent application for clarity purposes. However, the present invention contemplates linking to any and all types of stereo vision methods now known or later developed.

Likewise, the stereo imagery data may include but are not limited to collision scenarios. For example, detection, tracking, classification, steering, collision detection, and/or avoidance scenarios may include detection, classification and tracking of an object, a collision between two objects, a collision between two vehicles (with different angles of approach), a collision between a vehicle and an object (e.g., utility pole, tree, street sign post, and the like) or a vehicle and a pedestrian or bicyclist. It may include methods of steering and/or avoidance of the above. Environmental conditions may include one or more of clutter from trees, street signs, utility poles, and the like, road and other surrounding features, sky, fog, rain, snow, lighting, time of day (sun glare, dusk, and the like) and terrain and/or road variations or any combination thereof.

Generating accurate stereo imagery data for stereo image methods is important in the process of testing and verifying those methods such as detection, tracking, classification, steering, collision, and/or avoidance methods, for example. Crashing real or toy vehicles can be cost prohibitive and time consuming. Embodiments of the present invention, therefore, are valuable in generating stereo imagery data to realistically simulate a matrix of vehicle steering and/or collision scenarios safely and in a controlled manner for use to test methods.

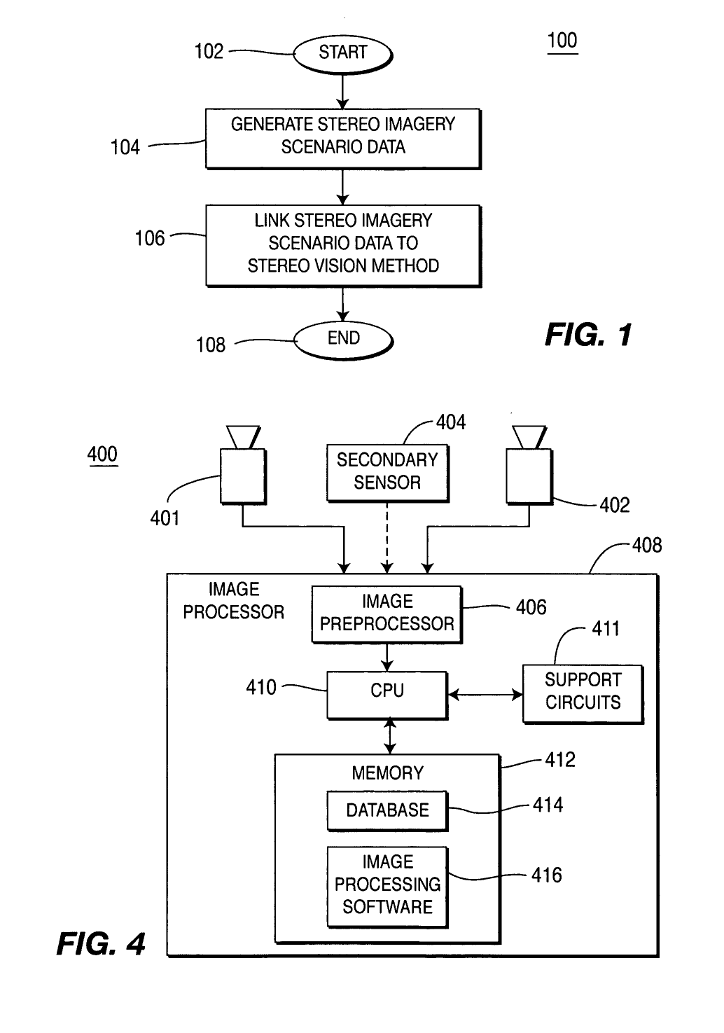

FIG. 1 depicts a flow diagram of a method 100 for generating stereo imagery or vision scenario data. The method begins at step 102 and proceeds to step 104. In step 104, stereo imagery scenario data is generated. In step 106, that data is fed into or linked to a stereo vision method for testing the method. In this particular example, a detection, tracking, classification, steering, collision detection and/or avoidance method system or any combination thereof is under test. This embodiment of a method of the present invention ends at step 108.

In step 104, the stereo imagery or vision scenario data may be generated with the use of a commonly available computer graphics card, for example a Nvidia GeForce FX 5700LE. Modern advances in computer-generated imagery (CGI) have been tremendous in the past few years. Ordinary PCs (personal computers) include advanced CGI cards more powerful than supercomputer performances of only a few years ago. Such hardware CGI cards are commonly used in video games, including realistic driving/racing simulators, but they can also be used for generating the realistic stereo imagery in a completely controlled fashion, alternating vehicle models, textures, trajectories and dynamics, as well as illumination variations, including twilight, nighttime and direct sunlight scenarios, and other environmental effects, such as rain, snow, fog, and the like.

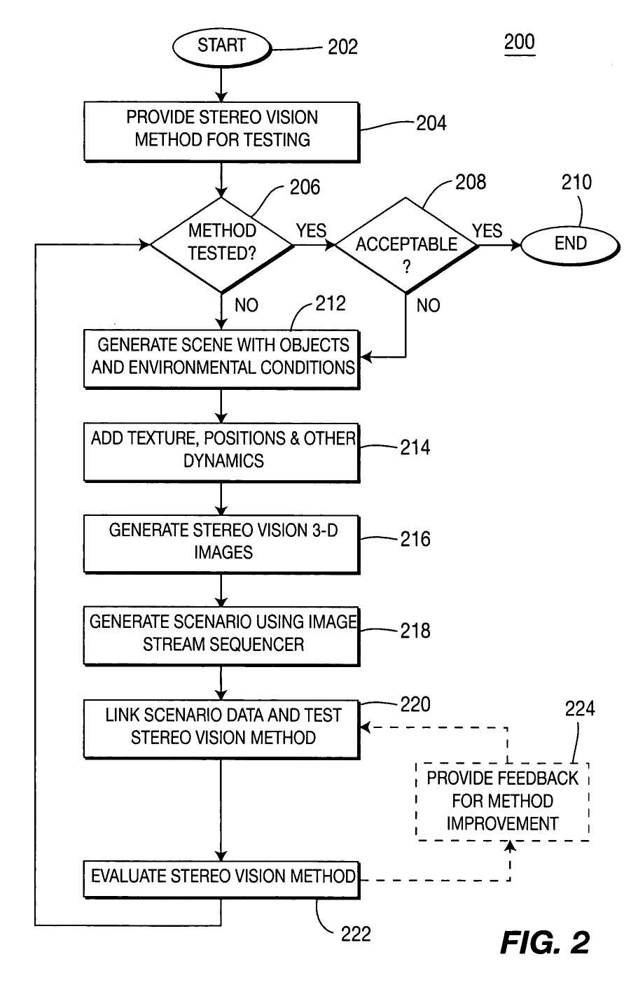

Step 104 may also include generation of a matrix of each scenario as one axis, with a specific environmental/illumination condition as the other axis, or combinations thereof. Such repeatability is not possible with real vehicles or toy models. Details of these embodiments are discussed with respect to FIG. 2.

FIG. 2 illustrates a method in accordance with another embodiment of the present invention for generating stereo imagery scenario data and linking same to a stereo vision method under test. Specifically, FIG. 2 depicts a flow diagram of a method 200 for generating collision scenario data. The method 200 begins at step 202 and proceeds to step 204. At step 204, a predetermined method is provided for testing and verification purposes. Step 206 queries whether the method has been tested. If the answer to that query is “Yes,” the method continues to step 208, where a separate query questions whether, in reviewing the resulting data obtained during the method test, the method performed as anticipated. If the answer to the query at step 208 is yes, then the method ends at step 210.

If, on the other hand, the answer to the query at step 206 or step 208 is “No,” the method continues to step 212. At step 212, at least one scene of a requested predetermined scenario is generated and populated with objects and environmental parameters/conditions such as weather, illumination, and the like.

The objects may range from one or more of host vehicles, target vehicles, roads, intersections, trees, pedestrians, bicyclists, street signs, road types, or terrain types, and the like. These parameters are capable of being provided in a range of conditions and combinations. For instance, one axis may be illumination. A user may choose anywhere from pitch black night time to a bright, sunny day at high Noon. Alternatively, a user can choose from between completely dry day to a torrential down pouring rainfall. Other axis of parameters are available and fully contemplated and within the scope of the present invention.

One embodiment for populating the at least one scene is through an interactive GUI. In this regard, computer generated objects and environmental parameters are selectable and dragable into each scene. Each scene may therefore be generated by using interactive GUI software to populate the image scene with objects and parameters. In one embodiment, a request may be made for a particular stereo imagery scene. Using an interactive GUI, objects are selected and placed in the scene template. Other parameters are also included in the scene template such as, for example, location of the objects, trajectory, and direction and speed vectors of the objects (assuming the objects will be moving). Further parameters and conditions, such as environmental, if requested, are placed into the stereo imagery scene. Exampled include illumination, rain, fog, road conditions, and the like.

Once the scene has been generated, the objects are related with reference to each other and the background of the scene. That is, roads, intersections, number of objects, and the like are related within the newly created scene. Then, the scene is rendered using commonly available graphics functions software such as OpenGL or GraphX type software. The output of this stereo imagery scene is effectively what two stereo cameras, for example mounted on a windshield of a vehicle, would see. This newly generated scene is then used in combination with other generated scenes, generated in a similar manner, to generate stereo imagery scenario data for testing the aforementioned methods.

The scenes may be generated in stereo vision or may alternatively be generated as one scene from the perspective of one camera. The system may then generate a stereo imagery scenario by generating a second scene from the perspective of a second camera, which would, for example, be offset horizontally from the first camera by some fixed distance, such as 7 inches (0.1778 meters).

The next step 214 comprises adding texture to the objects that have been added to the image scene, position values of the objects, velocity vectors and other dynamics. The texture being added to the objects can be added in any form or means known to those of ordinary skill in the art. For example, the texture can be simulated with a texture mapping method. That is, the texture can be synthetically generated in a manner known to one of ordinary skill in the art. Alternatively, the texture can be generated through image-based rendering. For example, the texture can be added and generated using a real photograph.

At step 216, stereo vision 3-D images of the scenes are generated using, for example, stereo imagery processing. This generation of 3-D imaging can be generated from the output of standard stereo rigging mounted on a vehicle, for example. It is important to note that there are at least two cameras to create a pair of stereo images. Therefore, stereo imagery for the generation of the 3-D image is generated. The 3-D image created is obtained given camera and optical parameters such as camera baseline, field of view, focal length, resolution, and the like. and from the stereo cameras' points of view.

Once the 3-D images are created, the next step 218 is to generate collision scenario data, i.e., simulated 3-D video of the generated scene imagery data. This scenario data may be generated using an image stream sequencer, which places the data into a compatible video format. An image stream sequencer that may be used is one provided by Sarnoff Corporation, commonly known as the Acadia Image Stream (AIS) format. At step 220, the now formatted simulated video or scenario data is linked to the method under test. The method is run and evaluated at step 222 to determine whether the method is working properly. Alternatively, step 224 provides a feedback loop to the method of the data resulting from a previous run with the scenario data. This feedback loop assists in improving the method under test during additional iterations.

A collision detection and/or avoidance method that may benefit from using the above described method of linking to stereo imagery scenario data for testing is described in co-pending, commonly assigned U.S. patent application Ser. No. 10/766,976, filed Jan. 29, 2004, the entire disclosure of which in incorporated by reference herein. Once the method, such as the one described in '976 patent application, is tested and accepted, the method ends at step 210 until the next stereo imagery scenario data is requested or another method is tested.

Simulating or synthesizing the collision scenarios is achieved through configuring what stereo cameras would see in a real set up. A scene is set up with a vehicle and two cameras mounted on the upper center of the windshield of the vehicle. For example, the host vehicle is configured to travel a certain speed and direction. The target vehicle is configured to travel a certain direction and speed. All the parameters of the cameras may be controlled with the interactive GUI. For example, the field of view, focal length, position and the like can be controlled.

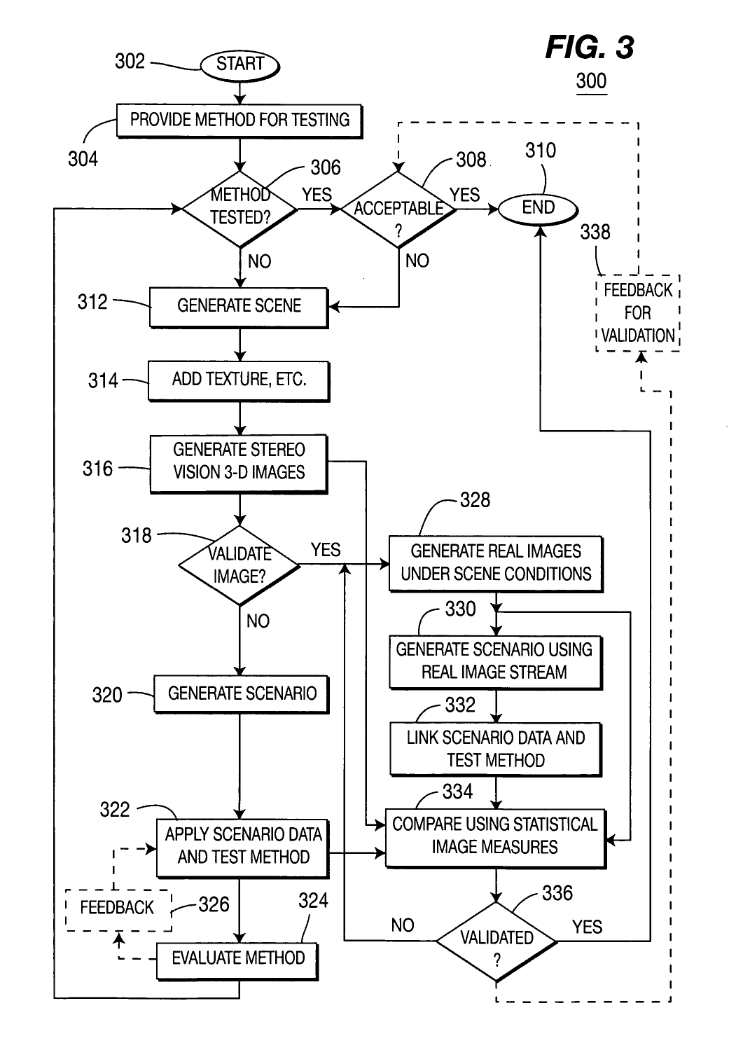

FIG. 3 illustrates a method in accordance with another embodiment of the present invention. Here, in addition to the above steps discussed with respect to FIG. 2, there is an added validation step 318, discussed in detail below. Thus, in this embodiment, the method illustrated is used for generating stereo imagery scenario data and linking that data to a stereo vision method under test.

Specifically, FIG. 3 depicts a flow diagram of a method 300 for generating collision scenario data. The method 300 begins at step 302 and proceeds to step 304. At step 304, a method is provided for testing and verification purposes. Step 306 queries whether the method has been tested. If the answer to that query is “Yes,” the method continues to step 308, where a separate query questions whether, in reviewing the resulting data obtained during the method test, the method performed as anticipated. If the answer to the query at step 308 is yes, then the method ends at step 310.

If, on the other hand, the answer to the query at step 306 or step 308 is “No,” the method continues to step 312. At step 312, at least one scene of a requested predetermined scenario is generated and populated with objects and parameters/conditions such as weather, illumination, and the like.

The next step 314 comprises adding texture to the objects that have been added to the stereo imagery scene, position values of the objects, velocity vectors and other dynamics. The texture can be added in any form or means known to those of ordinary skill in the art. At step 316, stereo vision 3-D images of the scenes are generated using, for example, stereo imagery processing. Once the 3-D images are created, the next step 318 queries whether the scenario is to be validated. If the answer to this query is “Yes,” then the method continues to step 328.

At step 328, real images are generated under the same scene conditions as the simulated scenario scenes. These real images can be generated using, for example, scale toy models and/or actual vehicles. At this point, the real images data is fed to the comparison step 334 to evaluate the data before a method is under test and compare it with the simulated images coming from step 316. If the real and simulated image data is acceptable, the method continues to step 330, where scenario data is generated using the real image stream from the previous step. Then, at step 332, the real scenario data is linked to the method under test. In the next step 334, the scenario data from the real image stream is compared to the simulated scenario data. At step 336, a query asks whether the simulated scenario data has been validated satisfactorily. If the answer to this query is “Yes,” then the method stops at step 310. If the answer is “No,” then the validation process is repeated. Feedback loops 326 and 338 are concurrently running to improve the simulated scenario data and validation data so that at some point during this iterative process, the simulated scenario data is sufficient to test the method of interest.

The method of validation may be by any means known by one of ordinary skill in the art. For example, one form of validation would be to compare some measure of output of the simulated scenario data with the output of the real data from real cameras. Some statistic, characterization, quality measure, output of collision method would be included as well. Then, these two sets of data would be compared. If there is a substantial match, then the synthetic or simulated image generation process would be validated.

In addition, a limited set of real-world test scenarios can be recorded with live video and can be compared with the corresponding simulated or synthetic video cases to validate the computer modeling process. Real-time generation of the synthesized stereo imagery is not necessary. Offline rendering into a compatible video format, such as AIS format, discussed above, is sufficient for the testing of these scenarios. Although the discussion herein refers to vehicles, it also equally applies to other objects involved in collision and driving scenarios, such as pedestrians, bicyclists, inanimate objects and other vulnerable road users. The embodiments of the present invention can also apply to other objects and vehicles such as ships, airplanes, trains and the like.

FIG. 4 depicts a block diagram of hardware 400 used to implement the methods discussed herein above. The stereovision imaging device comprises a pair of cameras 401 and 402 that operate in the visible wavelengths. The cameras have a known relation to one another, such that they can produce a stereo image of the scene from which information can be derived. This set up may be mounted on the windshield of a host vehicle, for example, as mentioned above.

The image processor 408 comprises an image preprocessor 406, a central processing unit (CPU) 410, support circuits 411, and memory 412. The image preprocessor 406 generally comprises circuitry for capturing, digitizing and processing the stereo imagery from the sensor array to image preprocessor 406. The image processor may be a single-chip video processor, such as the processor manufactured under the model Acadia I by Pyramid Vision Technologies of Princeton, N.J.

The processed images from the image preprocessor 406 are coupled to the CPU 410. The CPU 410 may comprise any one of a number of presently available high-speed microcontrollers or microprocessors. The CPU 410 is supported by support circuits 411 that are generally well known in the art. These circuits include cache, power supplies, clock circuits, input/output circuitry, a graphics card, and the like. The memory 412 is also coupled to the CPU 410. The memory 412 stores certain software routines executed by the CPU 410 and by the image preprocessor 408 to facilitate the operation of embodiments of the present invention. The memory 412 also stores certain databases 414 of information that are used by the embodiments of the present invention, and image processing software 416 used to process the stereo imagery data. Although embodiments of the present invention are described in the context of a series of method steps, the methods may be performed in hardware, software, firmware or some combination of hardware and software.

In relation to the methods described above regarding the generation of simulated stereo imagery data (see, e.g., FIGS. 2 and 3), the apparatus 400 may include image processor 408 without the real stereo cameras 401 and 402. In this embodiment, the graphics card located in the support circuitry 411 will be used to link to and access stored objects and/or parameters located in the database 414. Here, instead of real stereo images being received from the stereo cameras 401 and 402, simulated stereo images will be generated through the use of the graphics card and the stored objects and parameters. In one embodiment, the setting up of scenes will be performed with an interactive GUI, which may access and control the graphics card in the support circuitry 411 and database 414.

While the foregoing is directed to embodiments of the present invention, other and further embodiments of the present invention may be devised without departing from the basic scope thereof, and the scope thereof is determined by the claims that follow.

1. A method for testing a stereo vision method, comprising:
generating stereo imagery scenario data; and
linking the generated stereo imagery scenario data to the stereo vision method under test.

2. The method of claim 1, wherein the stereo vision method comprises at least one of: a detection method, a tracking method, a classification method, a steering method, a collision detection method, or an avoidance method.

3. The method of claim 2, wherein the generating step comprises populating at least one scene with at least one of: a computer generated relational object, or a computer generated relational parameter.

4. The method of claim 3, wherein the computer generated relational objects are selected from a group comprising at least one of: a vehicle model, a road sign, a barrier, a street, an intersection, a building, a tree, a utility pole, a pedestrian, a bicyclist, or a background object.

5. The method of claim 3, wherein the computer generated relational parameter is selected from a group comprising at least one of: an object position, an object direction, an object trajectory, an object texture, a scene illumination or a scene environmental condition.

6. The method of claim 1, wherein the generating step comprises:
generating stereo vision 3-D images; and
generating simulated scenario data from the generated stereo vision 3-D images using an image stream sequencer.

7. The method of claim 6, further comprising generating a plurality of stereo imagery scenes, wherein the plurality of stereo imagery scenes is used in the step of generating stereo vision 3-D images.

8. The method of claim 7, wherein the step of generating plurality of stereo imagery scenes comprises:
importing computer generated relational objects into each scene;
mapping the relational objects with texture;
arranging the relational objects in each scene in accordance with predetermined parameters; and
relating the objects in each scene in accordance with the predetermined parameters.

9. The method of claim 6, further comprising:
validating the generated simulated scenario data.

10. The method of claim 9, wherein the validating step comprises:
generating real images under scene conditions;
generating real scenario data using a real image stream;
linking the real scenario data to the method under test; and
comparing the test results generated from use of the simulated scenario data with the test results generated from use of the real scenario data.

11. The method of claim 10, wherein the comparison step comprising using statistical image measures to validate the simulated scenario data.

12. An apparatus for testing a stereo vision method, comprising:
means for generating stereo imagery scenario data; and
means for linking the generated stereo imagery scenario data to the stereo vision method under test.

13. The apparatus of claim 12, wherein the stereo vision method comprises at least one of: a detection method, a tracking method, a classification method, a steering method, a collision detection method, or an avoidance method.

14. The apparatus of claim 13, wherein the means for generating stereo imagery scenario data comprises means for populating at least one scene with at least one of: a computer generated relational object, or a computer generated relational parameter.

15. The apparatus of claim 14, wherein the computer generated relational object is selected from a group comprising at least on of: a vehicle model, a road sign, a barrier, a street, an intersection, a building, a tree, a utility pole, a pedestrian, a bicyclist, or a background object.

16. The apparatus of claim 14, wherein the computer generated relational parameter is selected from a group comprising at least one of: an object position, an object direction, an object trajectory, an object texture, a scene illumination, or a scene environmental condition.

17. The apparatus of claim 12, wherein the means for generating stereo imagery scenario data comprises:
means for generating stereo vision 3-D images; and
means for generating scenarios from the generated stereo vision 3-D images.

18. A computer-readable medium having stored thereon a plurality of instructions, which, when executed by a processor, cause the processor to perform the steps of a method for testing a stereo vision method, comprising:
generating stereo imagery scenario data; and
linking the generated stereo imagery scenario data to the stereo vision method under test.

19. The computer-readable medium of claim 18, wherein the stereo vision method comprises at least one of: a detection method, a tracking method, a classification method, a steering method, a collision detection method, or an avoidance method.

20. The computer-readable medium of claim 18, wherein the means for generating stereo imagery scenario data comprises means for populating at least one scene with at least one of: computer generated relational objects, or computer generated relational parameters.

21. The computer-readable medium of claim 20, wherein the computer generated relational objects are selected from a group comprising at least one of: a vehicle model, a road sign, an intersection, a barrier, a street, a building, a tree, an utility pole, a pedestrian, a bicyclist, or a background object.

22. The computer-readable medium of claim 20, wherein the computer generated relational parameter is selected from a group comprising at least one of: an object position, an object direction, an object trajectory, an object texture, a scene illumination or a scene environmental condition.

23. The computer readable medium of claim 18, wherein the generating step comprises:
generating stereo vision 3-D images; and
generating scenarios from the generated stereo vision 3-D images using an image stream sequencer.
